(19) United States
(12) Patent Application Publication
(10) Pub. No.: US 2026/0224067 A1
(43) Pub. Date: Aug. 6, 2026

(54) HEATING TRAY

(71) Applicant: OnKey Electronic Technology Co.,Ltd, DongGuan (CN)

(72) Inventor: Fen Liu, DongGuan (CN)

(21) Appl. No.: 19/026,757

(22) Filed: Jan. 17, 2025

(30) Foreign Application Priority Data
Aug. 30, 2024 (CN) 2024221330617

(51) Int. Cl. A47J 36/24; H05B 1/02; H05B 3/74

(52) U.S. Cl. CPC A47J 36/2483; H05B 1/0261; H05B 3/748; H05B 2203/003; H05B 2203/016; H05B 2203/028; H05B 2213/04; H05B 2213/07

(57) ABSTRACT

The present disclosure discloses a heating tray, which comprises a tray body, a heating wire, a mounting housing and a control circuit assembly, wherein the tray body is made of silica gel and integrally formed, the back of the tray body is provided with a plurality of supporting protrusions for supporting the tray body, one side of the back of the tray body is provided with a mounting groove; the heating wire is encapsulated in the back of the tray body; the mounting housing is arranged in the mounting groove, and the control circuit assembly is arranged in the mounting housing and is electrically connected with the heating wire.

This application is a national application of CN 202422133061.7, filed on Aug. 30, 2024. The contents of CN202422133061.7 are all hereby incorporated by reference.

### TECHNICAL FIELD

The present disclosure relates to the technical field of heating equipment, and in particular, relates to a heating tray.

### BACKGROUND

A heating tray or heating plate is a kind of equipment that can heat food and is widely used in restaurants or canteens. For example, some automatic restaurants may put dishes cooked in advance on the heating tray or heating plate to keep them at a suitable temperature, thereby effectively preventing the decline of the quality of the dishes and improving customer satisfaction. The first generation of food heating equipment is made of hard materials such as metal or glass as a whole, and thus it is very likely to get damaged when colliding with the bowls and dishes. The second generation of food heating equipment is made of flexible materials so that it can be folded and bent and is not easy to be damaged. In the prior art, the food heating equipment usually needs to be controlled by corresponding control components. The control components are usually exposed on the upper surface of the heating equipment, and the joint between the control components and flexible materials is not tightly sealed. When cleaning the heating equipment, water easily penetrates into the control components from the joint, and thus the equipment is easily damaged. Therefore, the existing food heating equipment has poor waterproof performance and is inconvenient to clean.

### SUMMARY

The technical problem mainly solved by the present disclosure is to provide a heating tray, which solves the problems of poor waterproof performance, inconvenient cleaning, uneven heating and temperature control safety of the existing food heating equipment.

In order to solve the above technical problems, a technical solution adopted by the present disclosure is to provide a heating tray which comprises: a tray body, being made of silica gel and integrally formed, the back of the tray body being provided with a plurality of supporting protrusions for supporting the tray body, one side of the back of the tray body being provided with a mounting groove; a heating wire, being encapsulated in the back of the tray body; a mounting housing, being arranged in the mounting groove, the lower surface of the mounting housing being higher than or flush with the lower end of the supporting protrusions; a control circuit assembly, being arranged in the mounting housing, being electrically connected with the heating wire and being configured to control the heating wire.

In some embodiments, the control circuit assembly comprises an electric energy transmission connector, a circuit board and a temperature protector, the sides of the mounting housing and the mounting groove are both provided with openings, the outer end of the electric energy transmission connector is provided with a socket which is exposed from the opening, the socket is used for connecting with an external power supply, the inner end of the electric energy transmission connector is electrically connected with the circuit board, the circuit board is electrically connected with the temperature protector, and the temperature protector is electrically connected with the heating wire.

The present disclosure further provides another heating tray which comprises: a tray body, being made of silica gel and integrally formed, the back of the tray body being provided with a plurality of supporting protrusions for supporting the tray body, one side of the back of the tray body being provided with a mounting groove; the back of the tray body being provided with a second accommodating groove, a heating wire being arranged in the second accommodating groove; a mounting housing, being arranged in the mounting groove; a control circuit assembly, being arranged in the mounting housing, being electrically connected with the heating wire and being configured to control the heating wire.

In some embodiments, the control circuit assembly comprises an electric energy transmission connector and a circuit board, the sides of the mounting housing and the mounting groove are both provided with openings, the outer end of the electric energy transmission connector is provided with a socket which is exposed from the opening, the socket is used for connecting with an external power supply, the inner end of the electric energy transmission connector is electrically connected with the circuit board, and the circuit board is electrically connected with the heating wire.

In some embodiments, the mounting housing comprises an upper housing and a lower housing which are detachably connected with each other, the lower end of the upper housing is provided with a clamping groove, the lower end of the mounting groove is provided with a clamping part that is clamped in the clamping groove, the bottom of the lower housing abuts against the lower end of the clamping part, and the side wall of the lower housing surrounds the outer surface of the mounting groove.

In some embodiments, the clamping part comprises an inward folded sub-portion and a vertical sub-portion, wherein the inward folded sub-portion is transversely connected to the lower end of the side wall of the mounting groove, the vertical sub-portion is connected to the inner end of the inward folded sub-portion, and the vertical sub-portion is clamped in the clamping groove.

In some embodiments, the heating tray further comprises a waterproof protector, the waterproof protector comprises a fixing part, an extension part and a sealing part which are connected in sequence, wherein the end of the mounting housing is provided with a fixing hole adapted to the fixing part, the fixing part is inserted into the fixing hole, the shape of the sealing part is adapted to the socket, and the sealing part is configured to be inserted into the socket.

In some embodiments, the mounting housing comprises an upper housing and a lower housing, the upper housing is further provided with an insertion slot at a position corresponding to the socket, and the power line connected with the electric outlet inside the socket is encapsulated in the insertion slot by epoxy resin.

In some embodiments, a bending part is formed at each of two ends of the heating wire which are adjacent to the circuit board, and a thermistor is arranged on the heating wire at the bending part along the width direction of the heating tray, and the thermistor is connected with the circuit board through a wire.

In some embodiments, the circuit board is provided with a printed circuit and welded with electronic components, including a plurality of key springs, a plurality of light emitting diodes and a buzzer.

In some embodiments, the mounting housing comprises an upper housing and a lower housing, and a plurality of first grooves which are concave outwardly are arranged on the inner top surface of the upper housing for correspondingly adapted to the plurality of key springs respectively.

In some embodiments, a plurality of key marks respectively corresponding to the plurality of key springs are printed on the front surface of the tray body and are used for sensing the operation of the key marks.

In some embodiments, the printed circuit comprises a power supply circuit connecting a first AC terminal and a second AC terminal, a heating control circuit and a controller; a first access terminal of the heating wire is electrically connected with the first AC terminal, a second access terminal of the heating wire is electrically connected with the second AC terminal through the heating control circuit, and the heating wire is connected between the first access terminal and the second access terminal of the heating wire; the controller has a heating control terminal connected to the heating control circuit for connection/disconnection control between the second access terminal of the heating wire and the second AC terminal, so as to control the power supply to the heating wire.

In some embodiments, the printed circuit further comprises a temperature sensing circuit that is connected with two temperature sensing input terminals, the two temperature sensing input terminals are connected with the thermistor through wires, and the thermistor is arranged close to the heating wire for sensing the temperature of the heating wire so as to change the voltage difference between the two temperature sensing input terminals; the temperature sensing circuit is electrically connected with the controller, and the voltage difference is input to the controller for monitoring the temperature of the heating wire.

In some embodiments, the printed circuit further comprises a detection circuit, and the detection circuit is electrically connected with both the first AC terminal and the controller for detecting the input alternating current.

In some embodiments, the tray body further comprises an arc-shaped portion which is located on one side of the tray body adjacent to the mounting groove, and the arc-shaped portion corresponds to the position of the socket and covers above the socket.

In some embodiments, the second accommodating groove is arranged on the back of the tray body in a linear circulating manner, the heating wire is encapsulated in the second accommodating groove by a sealing material, and the size of the opening of the second accommodating groove is smaller than the size of the bottom thereof.

In some embodiments, a warning sign is provided on the front surface of the tray body, and the color of the warning sign becomes red for warning of high temperature after the temperature of the heating tray rises above a predetermined value.

In some embodiments, the plurality of supporting protrusions are arranged on the back of the tray body at certain intervals in a crossed manner.

In some embodiments, the heating wire comprises a metal wire and a wrapping layer wrapped around the metal wire.

Beneficial effects of the present disclosure are as follows: in the present disclosure, by arranging the mounting groove on one side of the back of the tray body, arranging the control circuit assembly in the mounting housing, and arranging the mounting housing in the mounting groove, the upper surface of the tray body can be made into an integral piece entirely made of silica gel materials, and water will not penetrate into the mounting housing from the upper surface during cleaning, thereby realizing protection for the control circuit assembly, and providing better waterproof performance, more convenient cleaning, and safer heating during use.

### BRIEF DESCRIPTION OF THE DRAWINGS

FIG. 1 is a schematic exploded structural diagram according to an embodiment of the present disclosure.

FIG. 2 is a schematic structural diagram of the back according to an embodiment of the present disclosure.

FIG. 3 is a schematic structural diagram of the back of a tray body according to an embodiment of the present disclosure.

FIG. 4 is a schematic cross-sectional view according to an embodiment of the present disclosure.

FIG. 5 is a schematic structural diagram of a mounting housing according to an embodiment of the present disclosure.

FIG. 6 is an enlarged view at A in FIG. 2.

FIG. 7 is an enlarged view at B in FIG. 4.

FIG. 8 is a schematic structural diagram of a sealing member according to an embodiment of the present disclosure.

FIG. 9 is a cross-sectional view of a heating wire sealed into a second mounting groove according to an embodiment of the present disclosure.

FIG. 10 is a schematic view illustrating the constitution of a circuit board according to an embodiment of the present disclosure.

FIG. 11 is a schematic structural diagram of the front face according to an embodiment of the present disclosure.

FIG. 12 is a top view of the interior of an upper housing according to an embodiment of the present disclosure.

FIG. 13 is a block diagram of a control circuit of a circuit board according to an embodiment of the present disclosure.

FIG. 14 is a schematic diagram of a power supply circuit and a heating control circuit of a circuit board according to an embodiment of the present disclosure.

FIG. 15 is a schematic diagram of a detection circuit of a circuit board according to an embodiment of the present disclosure.

FIG. 16 is a schematic diagram of a temperature sensing circuit of a circuit board according to an embodiment of the present disclosure.

FIG. 17 is a schematic diagram illustrating the arrangement of a thermistor according to an embodiment of the present disclosure.

FIG. 18 is a schematic view illustrating the arrangement of a thermistor according to an embodiment of the present disclosure.

FIG. 19 is a schematic diagram of a buzzer circuit of a circuit board according to an embodiment of the present disclosure.

### DETAILED DESCRIPTION

In order to facilitate the understanding of the present disclosure, the present disclosure will be described in more detail with reference to the attached drawings and specific embodiments. Preferred embodiments of the present disclosure are shown in the accompanying drawings. However, the present disclosure can be realized in many different forms and is not limited to the embodiments described in this specification. Rather, these embodiments are provided to make the disclosure of the present disclosure more thorough and comprehensive.

It shall be noted that unless otherwise defined, all technical and scientific terms used in this specification have the same meanings as commonly understood by those skilled in the art. The terminology used in the specification of the present disclosure is only for the purpose of describing specific embodiments, and is not intended to limit the present disclosure. The term “and/or” as used in this specification includes any and all combinations of one or more associated items listed.

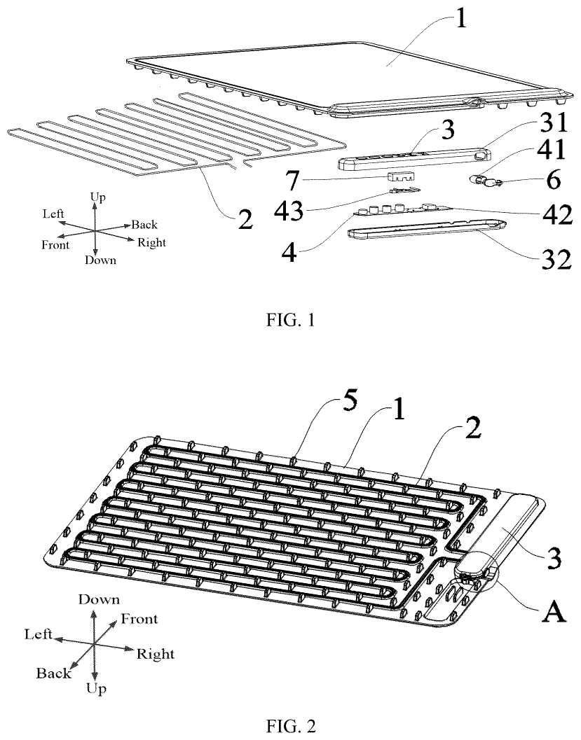

For the description of the present disclosure, the marks “front”, “rear”, “upper”, “lower”, “left” and “right” shown in FIG. 1 are used in a nonrestrictive manner to promote the understanding of this embodiment, and are not intended to limit the present disclosure. The front-back direction indicates the longitudinal direction, the left-right direction indicates the transverse direction, and the up-down direction indicates the vertical direction.

FIG. 1 to FIG. 8 show an embodiment of a heating tray according to the present disclosure, which comprises a tray body 1, a heating wire 2, a mounting housing 3 and a control circuit assembly 4, wherein the tray body 1 is made of silica gel and is integrally formed, the back of the tray body 1 is provided with a plurality of supporting protrusions 5 for supporting the tray body 1, and one side of the back of the tray body 1 is provided with a mounting groove 11. The heating wire 2 is encapsulated in the back of the tray body 1. The mounting housing 3 is arranged in the mounting groove 11 and it may be affixed to the mounting groove 11, and the lower surface of the mounting housing 3 is higher than or is flush with the lower end of the supporting protrusions 5. The control circuit assembly 4 is arranged in the mounting housing 3 and electrically connected with the heating wire 2, and the control circuit assembly 4 is used for controlling the heating wire 2.

There are two ways to encapsulate the heating wire 2 in the back of the tray body 1. The first way involves excavating a recessed groove inward in the back and embedding the heating wire into the back of the tray body. Alternatively, a second mounting groove may be arranged on the back outward, and the heating wire is put into the second mounting groove to be encapsulated, as shown in FIG. 9. The heating wire 2 may be arranged in concentric circles or continuous rectangles, or the heating wire 2 may be arranged in horizontal or vertical loops, as shown in FIG. 1, the heating wire 2 covers the back of the tray body evenly, which can ensure the uniform heating on the upper surface of the tray.

The dimensions of the embodiment in FIG. 1 may be 60 cm for the long side in the left-right direction, 40 cm for the wide side in the front-back direction, 1 cm for the height of the supporting protrusions 5, 3 mm for the thickness of the tray body, 5 cm for the interval between adjacent supporting protrusions along the length direction of the tray and 5 cm for the interval between adjacent supporting protrusions along the width direction of the tray, and the supporting protrusions in adjacent rows or columns are staggered. Adjacent heating wires are arranged at an interval of 26 mm, and the heating power that can be realized by this embodiment is 240 W. The preset heating temperatures may be 60° C., 80° C. and 100° C.

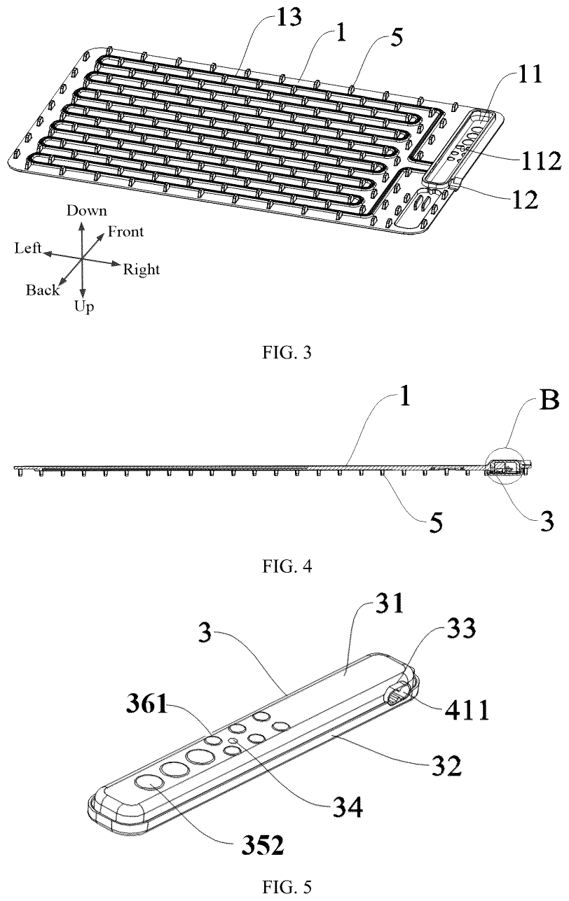

In some embodiments, as shown in FIG. 2 and FIG. 3, the plurality of supporting protrusions 5 are arranged at certain intervals on the back of the tray body 1 in a crossed manner, and this cross arrangement allows the force to be more evenly distributed among the supporting protrusions 5, thereby providing better supporting effect. As can be seen, the plurality of supporting protrusions 5 are staggered on the back of the tray body 1 at certain intervals, with the height of the supporting protrusions ranging from 0.5 cm to 2 cm. When the heating tray is placed flat on the table surface, a spatial gap can be formed between the tray body 1 and the table surface, which facilitates the heat dissipation at the back of the tray body 1 and avoids heating damage to the table surface that would occur if the back of the tray body 1 was directly placed on the table surface. Moreover, the supporting protrusions 5 are evenly distributed, which is beneficial to ensuring that the whole heating tray is stably placed on the table surface.

In the present disclosure, by arranging the mounting groove 11 on one side of the back of the tray body 1, arranging the control circuit assembly 4 in the mounting housing 3, and arranging the mounting housing 3 in the mounting groove 11, the upper surface of the tray body 1 can be made into an integral piece entirely made of silica gel materials, and water will not penetrate into the mounting housing 3 from the upper surface during cleaning, thereby realizing protection for the control circuit assembly 4, and providing better waterproof performance and more convenient cleaning.

In some embodiments, as shown in FIG. 1, FIG. 5 and FIG. 7, the mounting housing 3 comprises an upper housing 31 and a lower housing 32 which are detachably connected with each other, the lower end of the upper housing 31 is provided with a clamping groove 311, the lower end of the mounting groove 11 is provided with a clamping part 111 that is clamped in the clamping groove 311, the bottom of the lower housing 32 abuts against the lower end of the clamping part 111, and the side wall of the lower housing 32 surrounds the outer surface of the mounting groove 11. By clamping the clamping part 111 in the clamping groove 311 and meanwhile making the lower housing 32 surround the outer surface of the mounting groove 11, the side wall of the mounting groove 11 can be clamped between the upper housing 31 and the lower housing 32, so that water can be prevented from entering the housing from the joint between the upper housing 31 and the lower housing 32, and the waterproof effect is better.

In some embodiments, as shown in FIG. 7, the clamping part 111 comprises an inward folded sub-portion 1111 and a vertical sub-portion 1112, wherein the inward folded sub-portion 1111 is transversely connected to the lower end of the side wall of the mounting groove 11, the vertical sub-portion 1112 is connected to the inner end of the inward folded sub-portion 1111, and the vertical sub-portion 1112 is clamped in the clamping groove 311. Through the arrangement of the inward folded sub-portion 1111 and the vertical sub-portion 1112, the lower end of the inward folded sub-portion 1111 abuts against the bottom surface of the lower housing 32, and the vertical sub-portion 1112 extends upward along the inner end of the inward folded sub-portion 1111 and is clamped in the clamping groove 311, so that water can be effectively prevented from entering the mounting housing 3 and the sealing effect is better. Based on the structure of FIG. 7, the sealed bonding of the tray body 1 and the mounting housing can be well realized in this way, because the mounting groove 11 on the tray body 1 includes the clamping part 111 which further comprises the inward folded sub-portion 1111 and the vertical sub-portion 1112, and these structures are all formed integrally with the tray body 1 and are also made of rubber materials. Therefore, with the combination with the clamping groove 311 of the upper housing 31, and with the lower housing 32 covering the upper housing while surrounding the outer surface of the mounting groove 11, the side wall of the mounting groove 11 is clamped between the upper housing 31 and the lower housing 32, thus forming an enclosed space with good waterproof performance, and the control circuit assembly is arranged in the enclosed space to ensure the safety and waterproof operation of the control circuit assembly.

In some embodiments, as shown in FIG. 1 and FIG. 5, the control circuit assembly 4 comprises an electric energy transmission connector 41, a circuit board 42 and a temperature protector 43, the sides of the mounting housing 3 and the mounting groove 11 are both provided with openings 33, the outer end of the electric energy transmission connector 41 is provided with a socket 411 which is exposed from the opening 33, the socket 411 is used for connecting with an external power supply, the inner end of the electric energy transmission connector 41 is electrically connected with the circuit board 42, the circuit board 42 is electrically connected with the temperature protector 43, and the temperature protector 43 is electrically connected with the heating wire 2 or the circuit board 42 is directly connected with the heating wire 2. The external power supply is connected by providing the socket 411, power supply can be realized simply by plugging the power cord into the socket 411 during use, and the power cord can be detached during cleaning, which is more convenient and safe.

Further speaking, the temperature protector 43 is also known as a temperature switch. When the temperature flowing through the heating wire is too high and exceeds the limited temperature value of the temperature protector, the temperature protector will be disconnected to prevent the heating wire from continuously operating at high temperatures. Once the temperature drops below the limited value, the temperature protector will be reconnected to restore the normal connection state. The temperature protector 43 may be used as an optional component, and it is not necessary to use the temperature protector 43 when the circuit on the circuit board 42 can control the heating wire not to generate excessively high temperature.

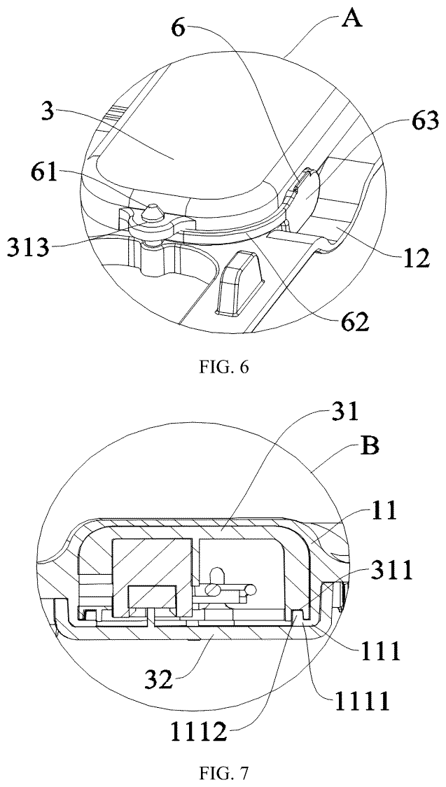

In some embodiments, as shown in FIG. 1, FIG. 5 and FIG. 6, the heating tray further comprises a waterproof protector 6 made of silica gel. The waterproof protector 6 comprises a fixing part 61, an extension part 62 and a sealing part 63 which are connected in sequence, wherein the end of the mounting housing 3 is provided with a fixing hole 313 adapted to the fixing part 61, the fixing part 61 is inserted into the fixing hole 313, the shape of the sealing part 63 is adapted to the socket 411, and the sealing part 63 is configured to be inserted into the socket 411. Before cleaning, the power cord is removed and the sealing part 63 is inserted into the socket 411, so that water can be prevented from entering the mounting housing 3 from the socket 411 during cleaning, and water can also be prevented from accumulating in the socket 411 and thus affecting the subsequent use.

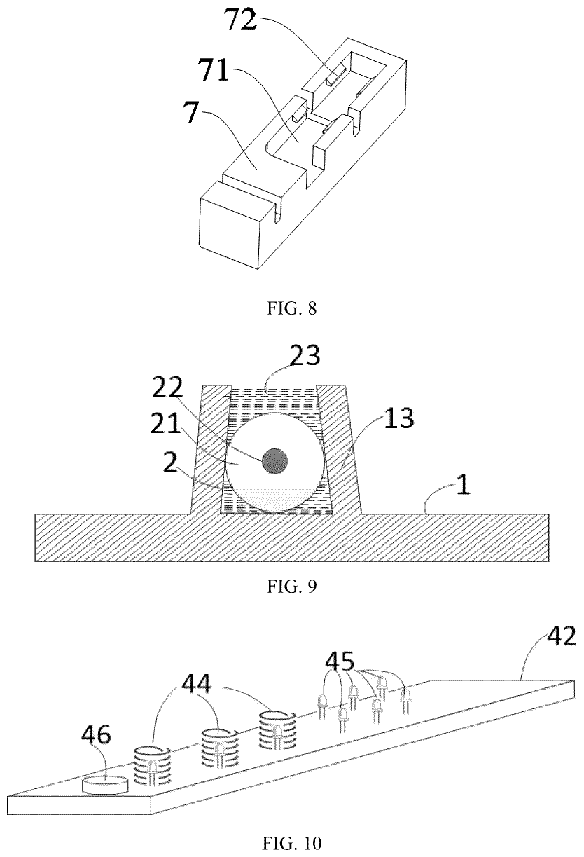

In some embodiments, as shown in FIG. 1 and FIG. 8, the mounting housing 3 is further provided with a sealing member 7 which is detachably connected with the mounting housing 3. The sealing member 7 is provided with a first accommodating groove 71 which is adapted to the temperature protector 43, and the temperature protector 43 is arranged in the first accommodating groove 71. The lower part of the first accommodating groove 71 is provided with a limiting protrusion 72 which abuts against the lower bottom surface of the temperature protector 43. By arranging the temperature protector 43 in the first accommodating groove 71, and making the limiting protrusion 72 abut against the lower bottom surface of the temperature protector 43, the temperature protector 43 can be sealed, and water is prevented from entering the mounting housing 3 and thus affecting the normal operation of the temperature protector 43.

In some embodiments, as shown in FIG. 3, FIG. 5 and FIG. 6, the tray body 1 further comprises an arc-shaped portion 12 which is located on one side of the tray body 1 adjacent to the mounting groove 11, and the arc-shaped portion 12 corresponds to the position of the socket 411. The arc-shaped portion 12 is in an upward convex arc shape, and covers above the socket 411. The arc-shaped portion 12 not only provides a space for the exposure of the socket 411, but also can prevent the water on the upper surface of the tray body 1 from flowing into the socket 411, so that the waterproof effect is better.

In some embodiments, as shown in FIG. 3 and FIG. 5, the mounting groove 11 is provided with a positioning protrusion 112, the mounting housing 3 is provided with a positioning hole 34 adapted to the positioning protrusion 112, and the positioning protrusion 112 is clamped in the positioning hole 34. When the mounting housing 3 is mounted, the positioning of the mounting housing 3 is realized by clamping the positioning protrusion 112 in the positioning hole 34, so that the mounting is faster and more convenient.

In some embodiments, as shown in FIG. 2 and FIG. 3, the back of the tray body 1 is provided with a second accommodating groove 13 adapted to the heating wire 2, wherein the second accommodating groove 13 is also integrally formed with the tray body 1, and the heating wire 2 is arranged in the second accommodating groove 13. During assembling, the heating wire 2 is first placed in the second accommodating groove 13, and then the second accommodating groove 13 is encapsulated with sealing material, so that the sealing effect is better. As can be seen from FIG. 3, the second accommodating groove 13 is arranged on the back of the tray body 1 in a linear circulating manner, so that the second accommodating groove is continuously and evenly distributed on the back of the tray body in the longitudinal and transverse directions. Thus, the main area of the tray body can be covered, and the uniform heating of the whole front surface of the heating tray is ensured. When sealing the heating wire in the second accommodating groove 13 with sealing material, the sealing material may be injected into the second accommodating groove 13 in a liquid form, and then the heating wire can be firmly sealed in the second accommodating groove 13 after the sealing material is solidified. The sealing material is conductive and insulating material, such as silica gel and rubber.

Further referring to FIG. 9, there is shown a cross-sectional view after the heating wire 2 is put into the second accommodating groove 13, and the sealing material 23 is injected around the heating wire 2. The heating wire 2 includes a metal wire 22 and a wrapping layer 21 wrapped around the metal wire 22. The wrapping layer 21 is also a conductive and insulating material, but it has good thermal conductivity, which is beneficial to transferring the heat generated by the metal wire 22 to the tray body 1. In addition, the metal wire 22 is spirally arranged within the wrapping layer 21, so that the length of the metal wire can be increased, which is beneficial for sufficient heating. Moreover, the flexibility or elasticity of the metal wire can be enhanced, so that the metal wire can be extended without being easily damaged by stretching when the tray is bent and folded.

The two side walls of the second accommodating groove 13 may be surfaces perpendicular to the tray body, or the two side walls may be obliquely arranged relatively close to each other, so that the size of the upper opening of the second accommodating groove 13 is formed smaller than the size of the bottom thereof, and the size of the upper opening of the second accommodating groove 13 is slightly smaller than the outer diameter of the heating wire. Because the second accommodating groove is made of rubber material, the heating wire can be forcibly clamped into the accommodating groove so that the heating wire will not easily fall off after being put into the second accommodating groove 13, and then the second accommodating groove 13 is sealed with a sealing material, as shown in FIG. 9.

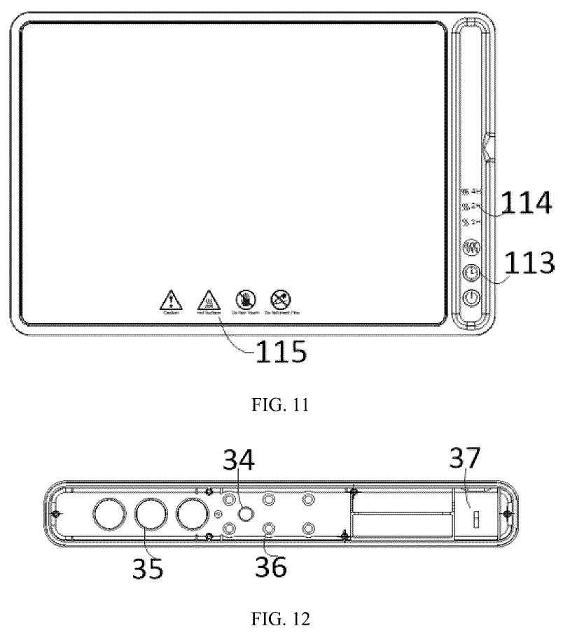

With reference to FIG. 10, the circuit board 42 is provided with a printed circuit board (PCB) and a plurality of welded electronic components, including a key spring 44, a plurality of light emitting diodes 45 and a buzzer 46. It can also be seen that a light emitting diode is also correspondingly provided in the middle of each key spring 44. With reference to FIG. 11, the key spring 44 can sense that the key mark 113 printed on the front surface of the tray body 1 is pressed or touched, which can then be recognized by the controller that the corresponding key mark 113 is pressed, and then corresponding operations can be performed. The key mark 113 includes: a power mark, which is used for power-on or power-off control; a heating mark, which is used for control of starting heating or stopping heating; a clock mark, which is used for setting the heating duration; and a lock mark, which is used for starting or stopping the lock for the key mark operation. The light emitting diode in the middle of the key spring 44 emits light when the corresponding key mark 113 on the front surface of the tray is operated effectively. For example, the light emitting diode emits light when the power mark indicates the device is powered on. The light emitting diode does not emit light when the key mark 113 is operated ineffectively. For example, the light emitting diode does not emit light when the power mark indicates the device is powered off. The plurality of light emitting diodes 45 correspond to the status mark 114 printed on the front surface of the tray body 1, and are used for correspondingly displaying different working states. If the heating duration is set to 1 hour, then the light emitting diode 45 under the status mark 114 corresponding to heating for 1 hour will emit light. If the heating duration is set to 2 hours, then the light emitting diode 45 under the status mark 114 corresponding to heating for 2 hours will emit light. If the heating duration is set to 4 hours, then the light emitting diode 45 under the status mark 114 corresponding to heating for 4 hours will emit light.

Further speaking, warning signs 115, such as Caution, Hot surface, Do not touch, Do not insert pins or the like are also provided on the front of the tray body. Moreover, the color of these warning signs can also change with the change of temperature. Especially, with the increase of the temperature, the colors of these warning signs become more vivid and eye-catching, which is beneficial to identifying the warning. For example, when the tray temperature is ≥113° F./45° C., the warning sign will change from brown to red. When the warning sign is red, it warns one do not touch the heating tray and the items on the heating tray; and when the warning sign is red, it warns one do not detach and store the heating tray.

The circuit board 42 needs to be installed in the upper housing 31, and the key spring 44, the plurality of light emitting diodes 45 and the buzzer 46 on the circuit board 42 in FIG. 10 are all installed toward the inner top surface of the upper housing 31. Therefore, with reference to FIG. 12, a plurality of first grooves 35 and a plurality of second grooves 36 are provided on the inner top surface of the upper housing, which are respectively used to accommodate the key springs 44 and the light emitting diodes 45 correspondingly. That is, the positions, shapes and sizes of the plurality of first grooves 35 and the plurality of second grooves 36 are correspondingly adapted to the positions, shapes and sizes of the plurality of key springs 44 and the plurality of light emitting diodes 45. In addition, since the positioning hole 34 is provided on the top surface of the upper housing 31, the first grooves 35 and the second grooves 36 will be matched with the corresponding key springs 44 and light emitting diodes 45 when the positioning protrusion 112 in the mounting groove 11 passes through the positioning hole 34.

In FIG. 12, since the first grooves 35 and the second grooves 36 are recessed outwardly from the inner top surface of the upper housing 31, referring to FIG. 5, the outer top surface of the upper housing 31 is correspondingly provided with first protrusions 352 and second protrusions 361, and the first protrusions 352 and the second protrusions 361 respectively correspond to the key mark 113 and the status mark 114 printed on the front surface of the tray body 1.

In FIG. 12, an insertion slot 37 is also provided in the upper housing at the position corresponding to the socket 411, and the power line connected with the electric energy transmission connector 41 inside the socket 411 is encapsulated in the insertion slot 37 by epoxy resin for sealing and waterproof operation of the power line.

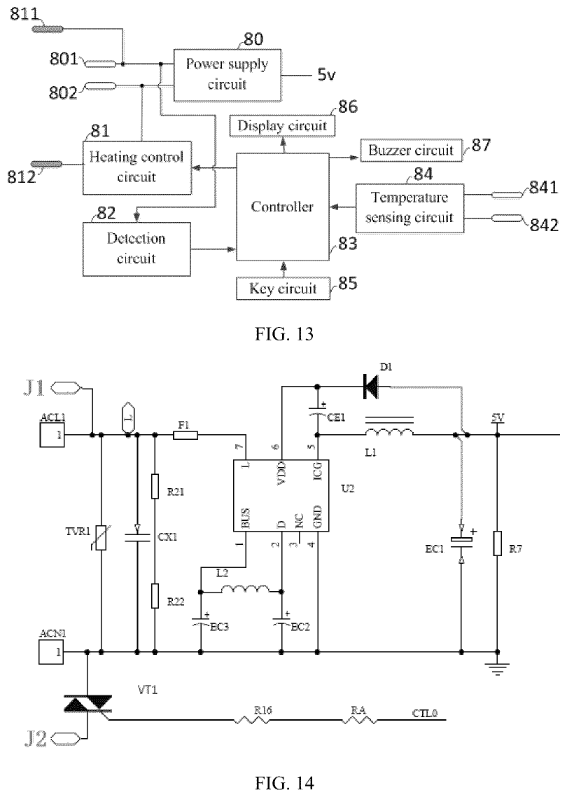

FIG. 13 is a schematic block diagram of the internal control circuit of the heating tray corresponding to the printed circuit on the circuit board 42, and FIG. 14 to FIG. 17 are schematic circuit diagrams for realizing the block diagram. This will be described in further detail below.

Referring to FIG. 13, the internal control circuit of the heating tray includes a power supply circuit 80 connecting a first AC terminal 801 and a second AC terminal 802, a heating control circuit 81, a detection circuit 82, a controller 83, a temperature sensing circuit 84, a key circuit 85, a display circuit 86 and a buzzer circuit 87.

The power supply circuit 80 is used to convert the input alternating current into direct current, and to provide direct current power supply, such as 5V power supply, to the detection circuit 82, the controller 83, the temperature sensing circuit 84, the buzzer circuit 87 or the like. A first access terminal 811 of the heating wire is electrically connected with the first AC terminal 801, and a second access terminal 812 of the heating wire is electrically connected with the second AC terminal 802 through the heating control circuit 81. The heating wire is connected between the first access terminal 811 and the second access terminal 812 of the heating wire. The controller 83 has a heating control terminal connected to the heating control circuit 81 for connection/disconnection control between the second access terminal 812 of the heating wire and the second AC terminal 802. For example, periodic pulses with different duty ratios are used for connection/disconnection control, so as to control the power supply to the heating wire and realize the regulation of different heating temperatures. In this way, the temperature can be rapidly raised at a relatively fast speed in the initial stage, for example, the surface temperature of the tray body can be raised to 40° C. by heating for 3 minutes, 60° C. by heating for 8 minutes and 80° C. by heating for 20 minutes, and then constant temperature heating can be carried out with low power consumption. Reference may be made to the circuit shown in FIG. 14 for the specific constitution of the power supply circuit 80 and the heating control circuit 81.

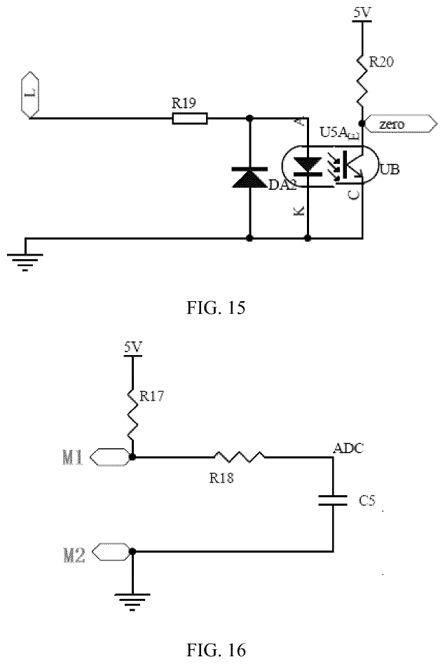

The detection circuit 82 is used for detecting the input alternating current, so the detection circuit 82 is electrically connected with the first AC terminal 801 for sampling the alternating voltage of the first AC terminal 801, and the sampled voltage value is input to the controller 83 for identifying and determining whether the input alternating current is normal or not. The alternating voltage of the second AC terminal 802 may also be sampled. Reference may be made to the circuit shown in FIG. 15 for the specific constitution of the detection circuit 82.

The temperature sensing circuit 84 is connected with two temperature sensing input terminals 841 and 842, which are connected with a thermistor through wires, and the thermistor is arranged near the heating wires for sensing the temperature of the heating wires and changing its resistance value with the change of the temperature, thereby changing the voltage difference between two ends of the thermistor located between the two temperature sensing input terminals 841 and 842. The temperature sensing circuit 84 collects the voltage difference between the two ends of the thermistor and inputs the voltage difference to the controller 83 for determining the heating temperature of the heating wire so that the heating power of the heating wire is regulated by the heating control circuit 81. Especially when the temperature sensed is too high, the heating power of the heating wire can be directly adjusted to be reduced.

Therefore, based on the cooperation of the temperature sensing circuit 84 and the heating control circuit 81, it can be ensured that the heating temperature is not too high, and therefore, it may be not necessary to use a temperature protector to protect the temperature from being too high. Moreover, this cooperative circuit relationship has good applicability, that is, it can be automatically regulated according to the different areas of the heating tray without designing a heating control solution separately because of the different areas of the tray. Furthermore, in the initial stage, the temperature can be quickly raised to the preset temperature, and then the heating tray operates at the constant temperature. This is also mainly due to the fact that the heating control circuit 81 controls the heating power to be large in the initial stage, while maintaining a small heating power in the constant temperature stage to maintain the constant temperature. The temperature measurement is realized by the temperature sensing circuit 84, so it has advantages of good user experience, reduced power consumption and power saving. As in the previous embodiment, the rated power is 240 W. Reference may be made to the circuit shown in FIG. 16 for the specific constitution of the temperature sensing circuit 84.

The key circuit 85 includes a key spring as shown in FIG. 10, which is electrically connected with the input pin of the controller 83. When the key mark 113 printed on the front surface of the tray body 1 is pressed or touched, the voltage of the corresponding input pin of the controller 83 will change, thereby performing key pressing recognition.

The display circuit 86 is a light-emitting diode or a digital display tube as shown in FIG. 10, and it is also electrically connected with the output pin of the controller 83 to correspondingly control the light-emitting diode to emit light or not, or to control the digital display tube to display numbers or letters.

The buzzer circuit 87 is used for sound alarm, and it is also electrically connected with the output pin of the controller 83 to correspondingly control the buzzer to emit sound or not.

The controller 83 may be a common single-chip microprocessor, such as a microprocessor with the model of OB38A16T2W28EP, which is mainly electrically connected with the heating control circuit 81, the detection circuit 82, the temperature sensing circuit 84, the key circuit 85, the display circuit 86 and the buzzer circuit 87 by using the IO pin and the AD pin therein, so as to input and output control signals and input sampling signals.

In FIG. 14, the power supply circuit 80 includes a power management chip U2 of which the model is OB2233EBCP-J for example. The seventh pin of the chip U2 is connected with the second end of a fuse F1, and the first end of the fuse F1 is connected with the first AC terminal ACL1 for connecting to the AC power and the first access terminal J1 of the heating wire. The first pin of the chip U2 is connected to the positive terminal of a third capacitor EC3, and the negative terminal of the third capacitor EC3 is connected to the second AC terminal ACN1. A second inductor L2 is connected between the first pin and the second pin of the chip U2, the second pin of the chip U2 is further connected with the positive terminal of a second capacitor EC2, and the negative terminal of the second capacitor EC2 is connected with the negative terminal of the third capacitor EC3 and connected with the second AC terminal ACN1.

A varistor TVR1 and an X capacitor CX1 are also connected in parallel between the first AC terminal ACL1 and the second AC terminal ACN1, and resistors R21 and R22 are connected in series and then arranged between these two AC terminals. These parallel components are mainly used for safety protection of the input AC power.

The sixth pin of the chip U2 is electrically connected with the negative electrode of a first diode D1 and the positive terminal of a first capacitor CE1, the fifth pin of the chip U2 is electrically connected with the negative terminal of the first capacitor CE1 and the first terminal of a first inductor L1, and the second terminal of the first inductor L1 is electrically connected with the positive terminal of the first diode D1 and also serves as DC output for outputting direct current of 5V for example. A capacitor EC1 and a resistor R7 are connected in parallel between the second end of the first inductor L1 and the fourth pin of the chip U2, and the fourth pin of the chip U2 is also used as a grounded pin for outputting direct current and is electrically connected with the negative terminal of the second capacitor EC2.

The heating control circuit in FIG. 15 includes a thyristor VT1, which has one connection terminal connected to the second access terminal J2 of the heating wire, and another connection terminal connected to the second AC terminal ACN1. The control terminal of the thyristor VT1, after being connected with a resistor R16 and a resistor RA in series, is electrically connected to a control pin CTL0 of the controller. High and low voltage signals are output through the control pin CTL0 to control the connection/disconnection of two connection terminals of the thyristor VT1, thereby regulating the average current acting between the first access terminal J1 and the second access terminal J2 of the heating wire, and thus further regulating the heating power of the heating wire.

In FIG. 16, the detection circuit includes an optical coupler U5A. The first input terminal A of the optical coupler is electrically connected to the first terminal of a resistor R19, and the second terminal L of the resistor R19 is electrically connected to the first AC terminal ACL1 in FIG. 14 for collecting the input AC power. The first end of the resistor R19 is electrically connected to the negative electrode of a second diode DA2, and the positive electrode of the second diode DA2 is grounded. The second input terminal K and the second output terminal C of the optical coupler are both grounded. The first output terminal E of the optical coupler is electrically connected to a resistor R20 and then connected to a DC power supply, such as a 5V DC power supply. At the same time, the first output terminal E of the optical coupler is also electrically connected with an input pin zero of the controller for detecting whether the alternating current is normally input. When the alternating current is input normally, the two input terminals of the optical coupler will be turned on and turned off periodically, so that the voltage of the input pin zero will change periodically between the power supply voltage and the ground voltage, and thus whether the input alternating current is normal is checked in this way. When no such periodical change occurs to the voltage of the input pin zero, it indicates that the input alternating current is abnormal, so the device will give an alarm or stop working.

In FIG. 16, the temperature sensing circuit includes a first temperature sensing input terminal M1 and a second temperature sensing input terminal M2, a thermistor is further electrically connected between these two temperature sensing input terminals, and the thermistor is arranged close to the heating wire, so the resistance value can be changed according to the temperature of the heating wire. The first temperature sensing input terminal M1 is further connected to the first terminal of a resistor R17, and the second terminal of the resistor R17 is connected to a DC power supply of for example 5V. Therefore, the thermistor and the resistor R17 are connected in series. Since the resistance value of the thermistor will change with the temperature of the heating wire, the voltage value at the first temperature sensing input terminal M1 will also change with the temperature of the heating wire, and this voltage value will be sampled. Therefore, the first temperature sensing input terminal M1 is further connected with the first end of a resistor R18, and the second end of the resistor R18 is electrically connected with an input pin ADC of the controller for sampling the voltage value of the first temperature sensing input terminal M1. The voltage value is an analog voltage value which will be converted into a digital voltage value after being sampled by the controller, and the digital voltage value will be recognized and known by the controller. The second end of the resistor R18 is further connected to a capacitor C5 and then grounded. The capacitor C5 has the function of filtering and stabilizing the sampling voltage of the temperature sensing circuit. Therefore, the temperature sensing circuit can convert the temperature of the heating wire into an acquisition voltage, and the controller can determine whether the temperature is within a reasonable range according to the acquisition voltage. If the temperature exceeds the reasonable range, regulation may be performed to ensure the heating safety.

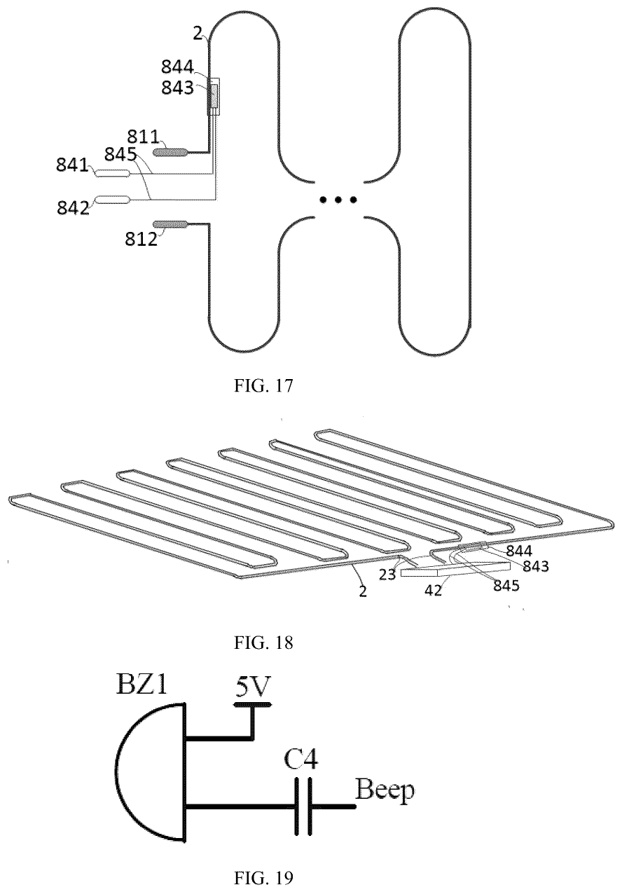

Referring to FIG. 17 and FIG. 13, a thermistor 843 may be provided near the first access terminal 811 or the second access terminal 812 of the heating wire 2 of the circuit board, and the thermistor only needs to be provided near one access terminal. The thermistor 843 is fixed to the heating wire through a heat shrinkable sleeve 844, and the two connection terminals of the thermistor 843 are connected to the two temperature sensing input terminals 841 and 842 of the temperature sensing circuit through two wires 845 respectively.

FIG. 18 further shows the position where the thermistor 843 is arranged. As can be seen, two ends of the heating wire 2 are respectively provided with two bending parts 24 near the circuit board, and the heating wire 2 is connected to the circuit board after being bent. The thermistor 843 is arranged on the heating wire 2 at the bending parts 24 along the front-back direction (the width direction of the heating tray as shown in FIGS. 1 and 2). That is, the thermistor is preferably arranged on the heating wire extending in the width direction of the heating tray. This is because that the heating tray is usually wrapped together in the left-right direction (the long side direction of the heating tray as shown in FIG. 1 and FIG. 2) when it is rolled up and not used, and the thermistor 843 will not easily get damaged due to wrapping when it is arranged on the heating wire 2 at the bending part 23 along the front-back direction. In addition, after the heating wire is bent, the length of the heating wire for connecting with the circuit board is very limited, which is only 3 to 4 cm, and the space for accommodating the thermistor is limited. FIG. 18 also shows that the thermistor 843 is fixed with the heating wire 2 through a heat shrinkable sleeve 844, and then connected to the circuit board 42 through two wires 845. Of course, the thermistor 843 and the heat shrinkable sleeve 844, together with the heating wire, are installed and sealed in the second accommodating groove.

In FIG. 19, the buzzer circuit includes a buzzer BZ1. The first end of the buzzer is connected to a DC power supply which is for example 5V, the second end of the buzzer is connected to one end of a capacitor C4, the other end of the capacitor C4 is electrically connected to an output pin Beep of the controller, and the output pin Beep outputs a control signal so that the buzzer BZ1 can emit sound.

As can be known from the above description, the present disclosure discloses a heating tray, which comprises a tray body, a heating wire, a mounting housing and a control circuit assembly, wherein a tray body is made of silica gel and integrally formed, the back of the tray body is provided with a plurality of supporting protrusions for supporting the tray body, one side of the back of the tray body is provided with a mounting groove; the heating wire is encapsulated in the back of the tray body; the mounting housing is arranged in the mounting groove, and the control circuit assembly is arranged in the mounting housing and is electrically connected with the heating wire. By arranging the mounting groove on one side of the back of the tray body, arranging the control circuit assembly in the mounting housing, and arranging the mounting housing in the mounting groove, the upper surface of the tray body can be made into an integral piece entirely made of silica gel materials, and water will not penetrate into the mounting housing from the upper surface during cleaning, thereby providing better waterproof performance and more convenient cleaning.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

1. A heating tray, being characterized in that, comprising:
a tray body, being made of silica gel and integrally formed, the back of the tray body being provided with a plurality of supporting protrusions for supporting the tray body, one side of the back of the tray body being provided with a mounting groove;
a heating wire, being encapsulated in the back of the tray body;
a mounting housing, being arranged in the mounting groove, the lower surface of the mounting housing being higher than or flush with the lower end of the supporting protrusions;
a control circuit assembly, being arranged in the mounting housing, being electrically connected with the heating wire and being configured to control the heating wire.

2. The heating tray according to claim 1, being characterized in that, the control circuit assembly comprises an electric energy transmission connector, a circuit board and a temperature protector, the sides of the mounting housing and the mounting groove are both provided with openings, the outer end of the electric energy transmission connector is provided with a socket which is exposed from the opening, the socket is used for connecting with an external power supply, the inner end of the electric energy transmission connector is electrically connected with the circuit board, the circuit board is electrically connected with the temperature protector, and the temperature protector is electrically connected with the heating wire.

3. A heating tray, being characterized in that, comprising:
a tray body, being made of silica gel and integrally formed, the back of the tray body being provided with a plurality of supporting protrusions for supporting the tray body, one side of the back of the tray body being provided with a mounting groove;
the back of the tray body being provided with a second accommodating groove, a heating wire being arranged in the second accommodating groove;
a mounting housing, being arranged in the mounting groove;
a control circuit assembly, being arranged in the mounting housing, being electrically connected with the heating wire and being configured to control the heating wire.

4. The heating tray according to claim 3, being characterized in that, the control circuit assembly comprises an electric energy transmission connector and a circuit board, the sides of the mounting housing and the mounting groove are both provided with openings, the outer end of the electric energy transmission connector is provided with a socket which is exposed from the opening, the socket is used for connecting with an external power supply, the inner end of the electric energy transmission connector is electrically connected with the circuit board, and the circuit board is electrically connected with the heating wire.

5. The heating tray according to claim 3, being characterized in that, the mounting housing comprises an upper housing and a lower housing which are detachably connected with each other, the lower end of the upper housing is provided with a clamping groove, the lower end of the mounting groove is provided with a clamping part that is clamped in the clamping groove, the bottom of the lower housing abuts against the lower end of the clamping part, and the side wall of the lower housing surrounds the outer surface of the mounting groove.

6. The heating tray according to claim 5, being characterized in that, the clamping part comprises an inward folded sub-portion and a vertical sub-portion, wherein the inward folded sub-portion is transversely connected to the lower end of the side wall of the mounting groove, the vertical sub-portion is connected to the inner end of the inward folded sub-portion, and the vertical sub-portion is clamped in the clamping groove.

7. The heating tray according to claim 4, being characterized in that, the heating tray further comprises a waterproof protector, the waterproof protector comprises a fixing part, an extension part and a sealing part which are connected in sequence, wherein the end of the mounting housing is provided with a fixing hole adapted to the fixing part, the fixing part is inserted into the fixing hole, the shape of the sealing part is adapted to the socket, and the sealing part is configured to be inserted into the socket.

8. The heating tray according to claim 4, being characterized in that, the mounting housing comprises an upper housing and a lower housing, the upper housing is further provided with an insertion slot at a position corresponding to the socket, and the power line connected with the electric energy transmission connector inside the socket is encapsulated in the insertion slot by epoxy resin.

9. The heating tray according to claim 4, being characterized in that, a bending part is formed at each of two ends of the heating wire which are adjacent to the circuit board, and a thermistor is arranged on the heating wire at the bending part along the width direction of the heating tray, and the thermistor is connected with the circuit board through a wire.

10. The heating tray according to claim 4, being characterized in that, the circuit board is provided with a printed circuit and welded with electronic components, including a plurality of key springs, a plurality of light emitting diodes and a buzzer.

11. The heating tray according to claim 10, being characterized in that, the mounting housing comprises an upper housing and a lower housing, and a plurality of first grooves which are concave outwardly are arranged on the inner top surface of the upper housing for correspondingly accommodating the plurality of key springs respectively.

12. The heating tray according to claim 10, being characterized in that, a plurality of key marks respectively corresponding to the plurality of key springs are printed on the front surface of the tray body and are used for sensing the operation of the key marks.

13. The heating tray according to claim 10, being characterized in that, the printed circuit comprises a power supply circuit connecting a first AC terminal and a second AC terminal, a heating control circuit and a controller;
a first access terminal of the heating wire is electrically connected with the first AC terminal, a second access terminal of the heating wire is electrically connected with the second AC terminal through the heating control circuit, and the heating wire is connected between the first access terminal and the second access terminal of the heating wire;
the controller has a heating control terminal connected to the heating control circuit for connection/disconnection control between the second access terminal of the heating wire and the second AC terminal, so as to control the power supply to the heating wire.

14. The heating tray according to claim 13, being characterized in that, the printed circuit further comprises a temperature sensing circuit, the temperature sensing circuit is connected with two temperature sensing input terminals, the two temperature sensing input terminals are connected with the thermistor through wires, and the thermistor is arranged close to the heating wire for sensing the temperature of the heating wire so as to change the voltage difference acting on the thermistor;
the temperature sensing circuit is electrically connected with the controller, and the voltage difference is input to the controller for monitoring the temperature of the heating wire.

15. The heating tray according to claim 13, being characterized in that, the printed circuit further comprises a detection circuit, and the detection circuit is electrically connected with both the first AC terminal and the controller for detecting the input alternating current.

16. The heating tray according to claim 4, being characterized in that, the tray body further comprises an arc-shaped portion which is located on one side of the tray body adjacent to the mounting groove, and the arc-shaped portion corresponds to the position of the socket and covers above the socket.

17. The heating tray according to claim 3, being characterized in that, the second accommodating groove is arranged on the back of the tray body in a linear circulating manner, the heating wire is encapsulated in the second accommodating groove by a sealing material, and the size of the opening of the second accommodating groove is smaller than the size of the bottom thereof.

18. The heating tray according to claim 3, being characterized in that, a warning sign is provided on the front surface of the tray body, and the color of the warning sign becomes red for warning of high temperature after the temperature of the heating tray rises above a predetermined value.

19. The heating tray according to claim 3, being characterized in that, the plurality of supporting protrusions are arranged on the back of the tray body at certain intervals in a crossed manner.

20. The heating tray according to claim 3, being characterized in that, the heating wire comprises a metal wire and a wrapping layer wrapped around the metal wire.
